(19) United States
(12) Patent Application Publication
(10) Pub. No.: US 2008/0141578 A1
(43) Pub. Date: Jun. 19, 2008

(54) MOSQUITO TRAP MEDIATED BY FILTRATED VISIBLE LIGHT EMITTING DIODE AND MOSQUITO BAIT

(75) Inventors: Chien-Lung Chen, Tainan City (TW); Hao-Jan Lin, Taipei (TW)

Correspondence Address: J C PATENTS, INC., 4 VENTURE, SUITE 250, IRVINE, CA, 92618, US

(73) Assignee: SONDLIN TECHNOLOGY CORP., Taipei City (TW)

(21) Appl. No.: 12/040,067

(22) Filed: Feb. 29, 2008

Related U.S. Application Data
(63) Continuation-in-part of application No. 11/400,562, filed on Apr. 7, 2006.

(30) Foreign Application Priority Data
Sep. 13, 2005 (TW) 94131435

(51) Int. Cl. A01M 1/04; A01M 1/22

(52) U.S. Cl. 43/113; 43/112; 43/131; 43/132.1

(57) ABSTRACT

The present invention provides a LED mosquito trap lamp combined with a liquid mosquito bait. The mosquito trap lamp further includes a bait-drawing means and a bait-releasing unit for assisting the emanation of the bait. The combination of ultra-violet light and the mosquito bait for attracting the mosquitoes proves to be effective and safe as the ultra-violet light is provided by using visible light LEDs in combination of the filter and the liquid bait is nontoxic to human beings.

### CROSS-REFERENCE TO RELATED APPLICATION

This application is a continuation-in-part of a prior application Ser. No. 11/400,562, filed Apr. 7, 2006, which claims the priority benefit of Taiwan application serial no. 94131435, filed on Sep. 13, 2005. The entirety of the above-mentioned patent application is hereby incorporated by reference herein and made a part of this specification.

### BACKGROUND OF THE INVENTION

1. Field of Invention

The present invention relates to an apparatus for trapping mosquitoes and insects. More particularly, the present invention relates to a mosquito trap lamp apparatus.

2. Description of Related Art

In warm and humid environments, mosquitoes have been a nuisance to the human beings. Not only its bites cause irritation and itchiness, mosquitoes may even epidemically transmit diseases, such as malaria, dengue fever, and Japanese meningitis, to individuals.

Mosquito-related products available in current markets include mosquito-repellent formulated as coil, pastille, or aerosols, and mosquito trap lamps. In most cases, the mosquito trap lamps employ ultra-violet (UV) light sources or fluorescent light sources for attracting insects. However, the airtight discharging lamp commonly used in the mosquito trap lamps is easily decayed over a short period of time and provides a broad region of spectrum, which may contain dangerous UV light causing damages of human eyes.

The mosquito trap lamps may further employ mosquito baits for enhancing the attraction of mosquitoes, and the attractants are of CO₂, highly volatile 1-octen-3-ol, pheromones, and compounds derived from human sweat, i.e. L-lactic acid, dibutyl succinate, or dimethyl disulfide. The inventors previously proposed to use microbial fermentation products as the mosquito attractant in terms of simulating the human sweat odors (U.S. Pat. No. 6,823,622). Nevertheless, it has been noticed that those mosquito attractants of pheromones, sweat chemicals or microbial fermentation solution are low volatility which results in mediocre attractive effects toward thus distant habitation of mosquitoes. Although highly volatile polar or non-polar solvents can be used to expel the attractants as aerosols, the highly volatile solvents in high concentrations may be harmful to human being. Hence, the resultant products are not suitable for using in closed spaces or indoors.

### SUMMARY OF THE INVENTION

This invention provides a mosquito trap lamp, which employs visible light LED with filters (filtrated visible light LED) for emitting UV lights. Instead of using gas discharging lamps, the lifetime of the mosquito lamp can be extended.

This invention provides a mosquito trap lamp, which employs a filtrated LED visible light set for emitting UV lights. Instead of using UV LED, the costs of the mosquito lamp can be decreased.

This invention also provides a mosquito trap lamp, which uses the piezoelectric vibrator for assisting the emanation of the mosquito bait(s) and for enhancing the efficiency of mosquito attraction. Moreover, the mosquito trap lamp can be used in closed environments or indoors.

As embodied and broadly described herein, the invention provides a mosquito trap lamp apparatus, including at least a casing, a lid, a LED light set, a bait-drawing means, a bait-releasing unit, a power supply and a mosquito destroying device. The LED light set is disposed on the lid and includes at least a visible light LED (bulb) and an ultra-violet (UV) band-pass filter covering the visible light LED. The apparatus may further include a fan disposed within the compartment.

As embodied and broadly described herein, the mosquito lamp apparatus described above also includes a liquid mosquito bait for enhancing attraction toward mosquitoes or insects. The mosquito lamp apparatus also includes a bait-drawing means and a bait-releasing unit for helping the discharge of the mosquito bait or its odors. The bait-releasing unit can be designed to employ the piezoelectric vibrator for assisting the emanation of the mosquito bait(s), in a physical and safer way. Moreover, at least a hole or slot can be designed in the casing for assisting odor emanation.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a schematic perspective view of an apparatus according to one preferred embodiment of the invention.

FIGS. 1B-1C are schematic top profile views of the apparatus in FIG. 1A, showing the lid 102 being closed or opened.

FIG. 1D is a schematic perspective view for the bait-drawing means according to one preferred embodiment of the invention.

### DESCRIPTION OF THE PREFERRED EMBODIMENTS

Although the term “mosquito trap lamp” is used herein and in the following contexts, the apparatus described hereafter is not limited to attract, trap or kill mosquitoes, but also may be applied to attract, trap or kill all other kinds of light or photo-tactic insects. Moreover, the apparatus of this invention is not limited to lamp shapes, but can be considered as light traps.

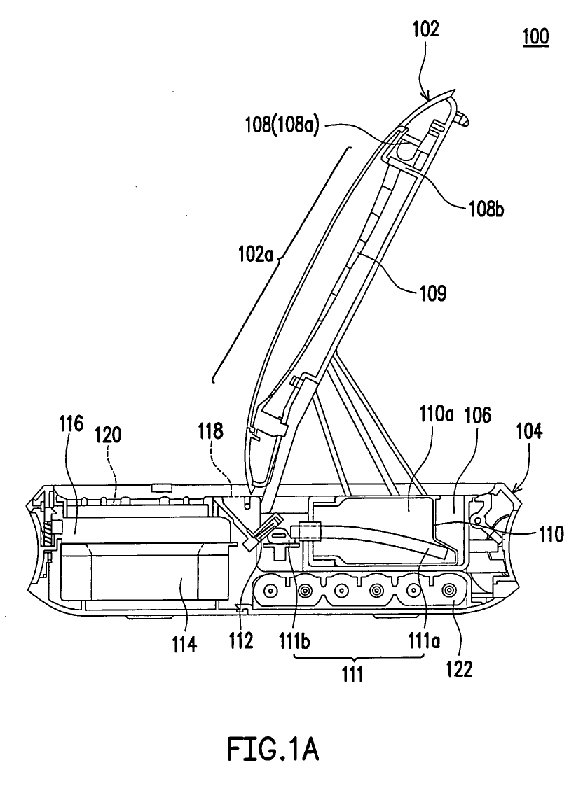

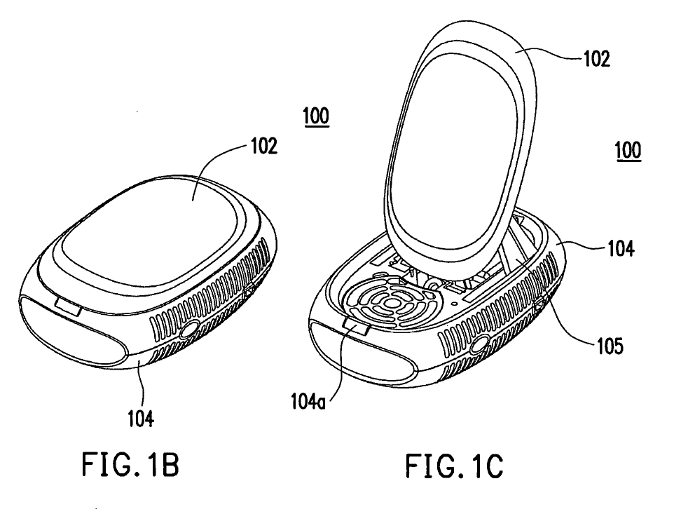

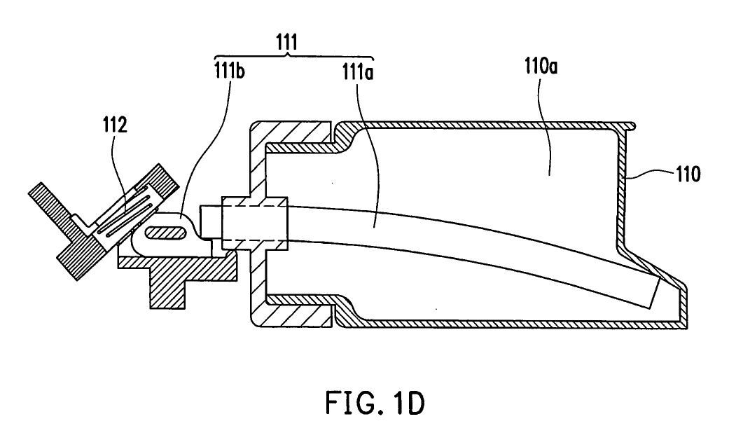

FIG. 1A is a schematic perspective view of an apparatus according to one preferred embodiment of the invention. FIGS. 1B-1C are schematic top profile views of the apparatus in FIG. 1A, showing the lid 102 being closed or opened. Referring to FIGS. 1A-1C, the mosquito trap lamp or apparatus 100 includes a lid or shield 102 disposed on top of the casing 104. When the lid 102 is closed or shut (covering the casing 104), the lid 102 is engaged to the casing through a tight-fitting mechanism, and the lid 102 can be released from the casing 104 through a push button 104a. The lid 102 is pivotally attached to the casing 104, for example, through a hinge joint mechanism with a cantilever 105. Preferably, when the lid 102 is open, the lid 102 is inclined at an angle and supported by the cantilever 105 and the lower end of the inclined lid 102 rests above the middle portion of the casing 104. Alternatively, the lid 102 can be closed or opened automatically through an automatic mechanical mechanism. A compartment 106 is defined by the lid 102 and the casing 104 when the lid 102 is closed to cover the casing 104.

The apparatus 100 also includes a light emitting diode (LED) light set 108, disposed in the lid 102. The LED light set 108 can emit lights toward the surroundings for attracting mosquitoes to the trap. As shown in FIG. 1A, the LED light set 108 includes at least one visible light emitting diode (LED) 108a and a filter sheet or film 108b covers the visible light LED 108a to screen the wavelength of (filter out) the light emitting from the LED 108a. According to the present invention, the LED light set 108 may includes a plurality of LEDs, in order to increase the light intensity (brightness or luminance). Beside the LED bulb 108a, a reflective surface or mirror 109 is further installed in the lid 102 for assisting the concentration or focus of lights from the LED bulb 108a. The above portion 102a of the lid 102 corresponding to the reflective surface or mirror 109 may be transparent or semi-transparent so as to boost light emission.

In this embodiment, the LED 108a is a LED emitting lights in visible light wavelengths (i.e. visible light LED in the range of 380 to 780 nm wavelength). However, LEDs in other wavelengths can be applicable. The filter sheet or film 108b is used to screen the light emitting from the LED bulbs and allows UV light (about 360 nm to 370 nm) passing through. That is, the visible light LEDs 108a in combination with the filter sheet 108b emit lights in the region of UV spectrum.

The filter sheet or film 108b can be a thin film filter, for example. Preferably, the thin film filter can be a band-pass thin film filter, fabricated by vapor depositing multiple highly reflective TiO₂ or Ti₂O₅ film layers repeatedly on a low reflective optical glass substrate, for passing certain band of wavelengths and filtering out wavelengths in other ranges. In this embodiment, the filter sheet 108b is a UV band-pass thin film filter glass slide. However, the filter sheet 108b is not limited by the embodiments herein, as long as the filter sheet can filter out undesired wavelengths and allow UV lights passing through.

The apparatus 100 further includes a mosquito bait container 110, a bait-drawing means 111 and a bait-releasing unit 112, disposed within the compartment 106. The bait container 110 may be designed to be detachably fixed within the compartment 106. Preferably, the bait container 110 is detachably disposed within the compartment 106 and can be removed for refilling the bait or replacing the container 110. Alternatively, the casing 104 may be designed to have an opening (not shown) for refilling the bait or replacing the container 110. The bait container 110 has at least a liquid mosquito bait 110a, and the mosquito bait includes at least a mosquito attractant. For example, the mosquito attractants can be selected from CO₂, 1-octen-3-ol, pheromones, L-lactic acid, dibutyl succinate or dimethyl disulfide, or even microbial (bacterial) fermentation products as disclosed in U.S. Pat. No. 6,823,622 (The entire disclosure of U.S. Pat. No. 6,823,622, filed on Jul. 19, 2002, is incorporated by reference). In this embodiment, the metabolites or fermentation products from specific bacterium strain cultivated in a predetermined medium is used as the mosquito attractant. The mosquito bait container 110 can be a tank, a bottle, a tube, a box or a cassette, depending on the design. Preferably, the mosquito bait is in a liquid state and suitable to be employed in conjunction with the bait-drawing means 111.

FIG. 1D is a schematic perspective view for the bait-drawing means according to one preferred embodiment of the invention. As shown in FIG. 1D, the bait-drawing means 111 includes at least a liquid-drawing element 111a and a liquid wicking element 111b. The liquid-drawing element 111a is mainly disposed in the container 110 and partially extrudes out of the container 110 to reach the liquid wicking element 111b. The liquid-drawing element 111a can be a bar, a column, a rod or a strip made of liquid absorbing materials, such as cotton, linen or the combination thereof, for example, so that the liquid mosquito bait 110a can be drawn from the bottom of the container 110 to the liquid wicking element 111b. The liquid wicking element 111b can be a sheet or a roll made of liquid absorbing materials, such as cotton, linen or the combination thereof, for example. The liquid wicking element 111b that is in direct contact with the bait-releasing unit 112 can transfer the liquid bait 110a to the bait-releasing unit 112 through capillary reactions. With the bait-drawing means incorporated in the apparatus, damping of the bait-releasing unit 112 due to siphonage or over-saturation can be avoided and the emanation efficiency and the stability can be further improved.

According to this embodiment, as shown in FIG. 1D, the bait-releasing unit 112 is disposed beside the bait container 110 and in direct contact with the liquid wicking element 111b. The bait-releasing unit 112 can be designed based on electronic vibration to use the ceramic piezoelectric vibrator for generating high frequency vibration wave (supersonic wave) to vaporize the liquid mosquito bait 110a into tiny or minute droplets (mist) for better emanation. For example, the bait-releasing unit 112 can be designed as the sprayer having a vibrating membrane having a plurality of tapered apertures, wherein the liquid adheres to the large openings of the apertures by surface tension and then ejects from the small openings of the apertures (the detailed mechanisms are disclosed in U.S. Pat. No. 7,083,112 and its entire disclosure is incorporated by reference). This design for releasing baits based on physical methods is safer and suitable for the outdoors, indoors use or in a closed space. Moreover, in the use in outdoors, indoors or a closed space, the bait-releasing unit 112 can increase the efficiency for attracting mosquitoes significantly. For example, under the supersonic wave of 1.6 million hertz (MHz), the vaporized particles (droplet) of water have diameters of about 3 microns. In general, using electronic circuits for controlling the frequency of the vibrator, it is possible to control diameters of the vaporized particles (droplet) of the bait liquid ranging from 0.5-6 microns, for example. Since the vaporized mist of the bait liquid can easily travel along with the gas flow, the odors of the bait can be spread out to increase the attraction for mosquitoes or insects. In this embodiment, the parameters of the supersonic vibrator are as follows: [frequency (Hz):1.6 MHz˜2.5 MHz, resistance (Ω)≦2.0, capacitance (PF): 1200˜2000]. By using the vibrator, the bait liquid is vaporized into minute droplets for easy emanation and the effective distance for attracting mosquitoes can be increased.

Referring back to FIGS. 1A-1C, the apparatus includes a fan 114 set inside the compartment 106 and under the lid 102. The fan 114 can be designed to blow air inwardly or the fan 114 is used in combination with a vacuum pump (not shown) for drawing air inwardly for trapping mosquitoes or insects and/or for helping odor emanation.

The compartment 106 further includes a mosquito destroying device 116, for example, an insect web, an electric grid (web) or a sticky web with or without a pesticide. Preferably, the insect web is employed to trap the allured mosquitoes or insects and the trapped mosquitoes are killed naturally by dehydration. The mosquito destroying device 116 may be disposed above or below the fan 114 in the compartment 106. The casing 104 includes at least a ventilation hole or slot 118 above the bait-releasing unit 112, for assisting air flow or ventilation, and assisting the release or oozing of the vaporized bait droplets for odor emanation. The casing 104 includes a plurality of holes or slots 120 above the mosquito destroying device 116 and the fan 114, for allowing the entry of mosquitoes for trapping purposes. A power supply 122 is included in the apparatus 100 for supplying electricity to the light set 108, the bait-releasing unit 112, the fan 114 and/or the electric grid. If the apparatus is applied for indoor uses, the power supply can be coupled to a DC power source by a plug. However, the power supply can be powered through batteries or solar cells, if the apparatus 100 is designed as portable or applied outdoors. The design of the power supply is well known to one skilled in the art and will not be described in details herein.

In summary, the mosquito trap lamp or apparatus described in this invention can be designed to be used indoors or outdoors, or to be portable or fixed to the walls, cars, or other suitable positions. The shapes or layouts of the mosquito lamp or apparatus described in this invention can be varied or adjusted according to requirements of fabrication or intended applications, cost considerations or appeals to potential consumers.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mosquito trap lamp apparatus, comprising:
a casing;
a lid, pivotally attached to and disposed on the casing, wherein a compartment is defined by the casing and the lid;
a light emitting diode (LED) light set, disposed on the lid, wherein the LED light set comprises at least a visible light LED, and the visible light LED is covered by an ultra-violet (UV) band-pass filter;
a bait container disposed in the compartment, wherein the bait container comprises a liquid mosquito bait;
a bait-releasing unit disposed in the compartment and below the bait container;
a bait-drawing means disposed between the bait container and the bait-releasing unit, for drawing the liquid mosquito bait in the bait container to the bait-releasing unit;
a fan disposed under the lid and in the compartment;
a mosquito destroying device disposed in the compartment; and
a power supply disposed in the compartment, wherein a plurality of holes is disposed on sidewalls of the lid and the casing and the holes consist of airing pathways for assisting air flow.

2. The apparatus as claimed in claim 1, wherein the LED light set further comprises a reflective surface disposed beside the visible light LED.

3. The apparatus as claimed in claim 1, wherein the bait-drawing means comprises a liquid-drawing element and a liquid wicking element disposed between the liquid-drawing element and the bait-releasing unit, wherein the liquid-drawing element partially extrudes out of the bait container and contacts with the liquid wicking element.

4. The apparatus as claimed in claim 3, wherein the liquid-drawing element is made of a liquid absorbing material.

5. The apparatus as claimed in claim 4, wherein the liquid absorbing material is cotton, linen or the combination thereof.

6. The apparatus as claimed in claim 3, wherein the liquid wicking element is made of a liquid absorbing material.

7. The apparatus as claimed in claim 6, wherein the liquid absorbing material is cotton, linen or the combination thereof.

8. The apparatus as claimed in claim 1, wherein the bait-releasing unit comprises a ceramic piezoelectric vibrator.

9. The apparatus as claimed in claim 1, wherein the bait container is detachably fixed within the compartment.

10. The apparatus as claimed in claim 1, wherein the mosquito destroying device is an electric grid, a sticky web or an insect web.

11. The apparatus as claimed in claim 1, wherein the mosquito destroying device is disposed below the fan.

12. The apparatus as claimed in claim 1, wherein the mosquito destroying device is disposed above the fan.

13. The apparatus as claimed in claim 1, wherein the mosquito bait comprises a material selected from the group consisting of CO₂, 1-octen-3-ol, pheromones, L-lactic acid, dibutyl succinate, dimethyl disulfide, and a microbial fermentation product.

14. The apparatus as claimed in claim 1, wherein the UV band-pass filter is an UV band-pass filter glass slide for generating UV light with a wavelength of about 360 nm-370 nm.
